(19) United States
(12) Patent Application Publication
(10) Pub. No.: US 2012/0135383 A1
(43) Pub. Date: May 31, 2012

(54) MEAL PLATE FOR GUIDING CORRECT EATING HABITS AND ADJUSTING AMOUNT OF MEAL

(75) Inventors: YongWon JANG, Daejeon (KR); Hyung Wook NOH, Daejeon (KR); Inbum LEE, Daejeon (KR); Yoon Seon SONG, Daejeon (KR); Sooyeul LEE, Daejeon (KR)

(73) Assignee: Electronics and Telecommunications Research Institute, Daejeon (KR)

(21) Appl. No.: 13/286,580

(22) Filed: Nov. 1, 2011

(30) Foreign Application Priority Data
Nov. 29, 2010 (KR) 10-2010-0120007

(51) Int. Cl. G09B 19/00

(52) U.S. Cl. 434/127

(57) ABSTRACT

A meal plate includes: a plurality of container receiving parts for receiving a container to serve food; an input part for inputting the kind of the food served in the container which is received in the container receiving parts; a measuring part disposed under the container receiving part for measuring information of the food served in the container; a storage part for storing the information of the food measured in the measuring part; and a communication part for transmitting the information of the food stored in the storage part to a user terminal.

### CROSS-REFERENCE TO RELATED APPLICATIONS

This application is based on and claims priority to, and the benefit of, Korean Patent Application No. 10-2010-0120007, filed on Nov. 29, 2010, with the Korean Intellectual Property Office, the disclosure of which is incorporated herein in its entirety by reference.

### BACKGROUND OF THE INVENTION

1. Field of the Invention

The present invention relates to a meal plate performing functions for guiding a user in proper amounts of a meal and balanced eating habits. More particularly, the present invention relates to a functional meal plate having sensors to measure the weight of food and the salt content thereof, which can help a user to manage his/her health in various and comprehensive aspects by transmitting information related to the food taken by the user to a user's terminal.

2. Description of the Prior Art

As generally known in the art, in order to limit calories consumed by a user a method has been used to give a feedback such as a warning sound or the like to the user when the user takes in the calories exceeding the predetermined level through measurements of the amount of food taken by the user.

However, such a conventional method has drawbacks in that it only calculates the calories of the food consumed by the user, but it cannot measure other important factors such as a salt quantity contained in the food or temperature of the food or the like. Moreover, the conventional method does not provide a monitoring function on middle and long term based eating habits.

In the case of the conventional method, it may have drawbacks in that since the quantity of the food is measured only at the beginning, the amount of the food eaten by the user cannot be exactly measured when he/she leaves some food. In addition, since the conventional method gives a feedback like a warning sound to the user every meal, it may deliver an unpleasant feeling or a burden to the user. Further, there has been a limitation to select a menu on special food or dishes, or states of cooking due to the limited selection on the kinds of food.

Therefore, there has been a need to develop technologies which are provided with a middle and long term based monitoring function on eating habits, performing measurements on the various factors of the food, which can effectively manage the eating habits depending upon the kinds and cooking states of the food through categorical classifications on the various food, and which can allow the user to easily check such information in connection with an associated user terminal such as a smartphone, a personal computer or the like.

### SUMMARY OF THE INVENTION

Accordingly, the present invention has been made to solve the above-mentioned problems occurring in the prior art, and the present invention is capable of guiding a user to correct eating habits on the middle and long term basis, wherein a sensor for measuring a food weight measures an amount of the food eaten by the user, wherein a sensor for measuring a salt content measures the salinity of the food, and wherein the user's eating habits during the predetermined period of time such as every day, week, month or the like are duly monitored.

An object of the present invention is to provide a meal plate which can give a user advice on middle and long term based eating habits and monitor the same by accurately measuring the food quantity eaten by the user and monitoring the meal information and the user's eating habits during a predetermined period of time such as every day, week, month or the like.

Another object of the present invention is to provide a meal plate further including a salinity sensor and a temperature sensor, which can guide a user to an improvement on effective eating habits. For instance, since salty food may increase the risk of various diseases, or hot food may damage the esophagus of the user, healthy eating habits can be obtained by taking into consideration the salt content and temperature of the food.

In order to accomplish an object of the present invention, there is provided a meal plate, including: a plurality of container receiving parts for receiving a container to serve food; an input part for inputting the kind of the food served in the container which is received in the container receiving part; a measuring part disposed under the container receiving part for measuring information of the food served in the container; a storage part for storing the information of the food measured in the measuring part; and a communication part for transmitting the information of the food stored in the storage part to a user terminal.

In accordance with another aspect of the present invention, there is provided a meal plate, including: a plurality of container receiving parts for receiving a container to serve food; a measuring part disposed under the container receiving part and provided with sensors to measure the weight, salinity and temperature of the food served in the container; a storage part for storing weight changes, salinity and temperature of the food measured in the measuring part; an outputting part for displaying the weight changes, salinity and temperature of the food; and a communication part for transmitting the weight changes, salinity and temperature of the food stored in the storage part to a user terminal.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view illustrating the shape of a functional meal plate in accordance with a preferred embodiment of the present invention;

FIG. 2 is an enlarged view illustrating the connection between a dedicated container in accordance with a preferred embodiment of the present invention and a measuring part within the meal plate;

FIG. 3 is a conceptual view illustrating the construction of the functional meal plate in accordance with a preferred embodiment of the present invention; and

FIG. 4 is a view illustrating a menu screen which can input the kind and cooking state of food.

### DETAILED DESCRIPTION OF THE PREFERRED EMBODIMENTS

Hereinafter, a preferred embodiment of the present invention will be described with reference to the accompanying drawings. The construction of the present invention and operational effects thereof will be clearly understood through the detailed descriptions hereinbelow.

In the following description and drawings, the same reference numerals are used to designate the same or similar components, and so repetition of the description on the same or similar components will be omitted. As to known constructional elements, it should be noted that their detailed description will be omitted in case that they may make the gist of the present invention unclear.

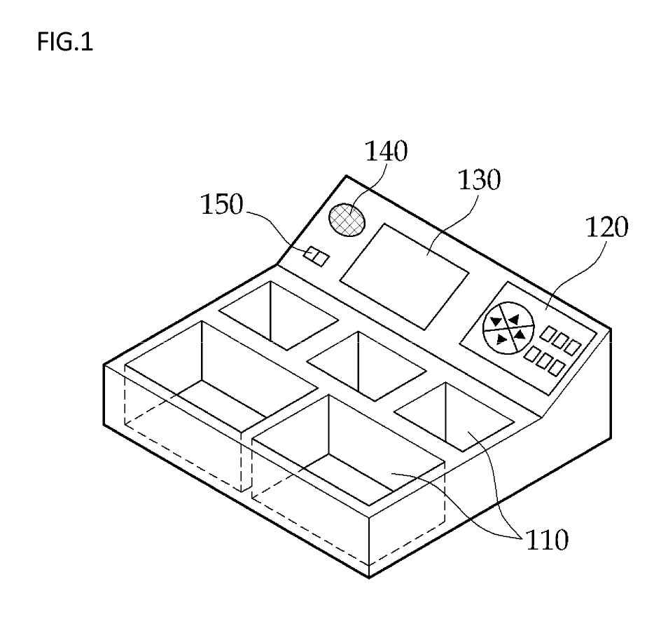

FIG. 1 is a perspective view illustrating the outer shape of a functional meal plate in accordance with a preferred embodiment of the present invention.

Referring to FIG. 1, the functional meal plate includes a plurality of container receiving parts 110, an input part 120, a display part 130, a speaker part 140, and a power source part 150.

The container receiving part 110 is formed in a concave shape from the upper portion of the functional meal plate to receive a dedicated container (not shown in FIG. 1) to serve the food. The container receiving part 110 may be formed in a proper number depending upon user's needs. As shown in FIG. 1, a plurality of container receiving parts 110 include a large container receiving part with a relatively large space formed at a lower side of the front surface of the functional meal plate, and a small container receiving part with a relatively small space formed at a upper side of the front surface of the functional meal plate. The large container receiving part is designed to accept a container for serving a main dish, such as steamed rice, a soup or the like. In contrast, the small container receiving part is used to receive a container for serving a small amount of food like a side dish.

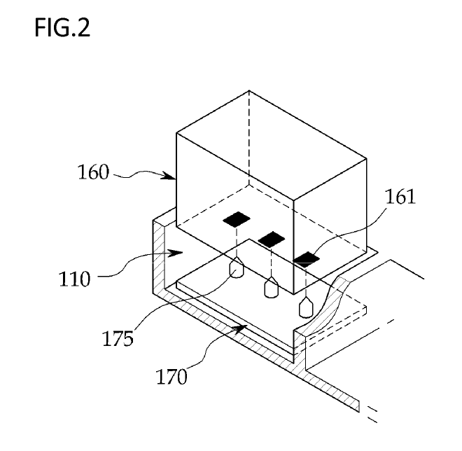

A dedicated container is adapted to be fittingly received in a space formed in the respective container receiving parts 110. An electrode formed at the dedicated container may be coupled with a measuring part (not shown in FIG. 1) which is disposed under the container receiving part 110 for measuring information of the food served in the dedicated container. The construction on the connection of the dedicated container with the measuring part under the container receiving part 110 will be described in detail with reference to FIG. 2 hereinafter.

The input part 120 is designed to perform an input operation of various information, such as the kind and cooking state of the food or the like served in the dedicated container which is received in the container receiving part 110. For instance, information of the food, i.e., the kind of steamed rice, a soup, or a side dish and whether the food and dishes are raw, seasoned, roasted, or steamed or the like, can be selectively inputted through the input part 120. The input part 120 may be embodied using a keypad including directional keys and couple of buttons or a touch screen, but not limited thereto.

The display part 130 plays a role as an image outputting part to display a variety of information, such as various menus, selection categories, and current states of the food or the like. The display part 130 may be composed of one out of the LCD (Liquid Crystal Display), PDP (Plasma Display Panel) or OLED (Organic Light-Emitting Diode), but is not limited thereto.

The speaker part 140 serves as a sound outputting part, which is capable of outputting the contents indicated in the display part 130 as a sound. The speaker part 140 can output a warning sound when the condition of the food or the feeding state of the user exceeds a standard predetermined range.

The power source part 150 performs an on/off control function of the power to the functional meal plate. When the functional meal plate is not in use, the power is off to reduce the power consumption. At this time, even though the power of the functional meal plate is off, the information necessary for the user is stored in the non-volatile memory, and not removed therefrom.

FIG. 2 is an enlarged view illustrating the connection between a dedicated container in accordance with a preferred embodiment of the present invention and a measuring part within the meal plate.

Referring to FIG. 2, a dedicated container 160 manufactured to be used in the functional meal plate is received in the container receiving part 110. The dedicated container 160 includes a plurality of electrodes 161 on the bottom surface thereof to measure information of the food, for example, weight, salinity, temperature or the like. When the dedicated container 160 is received in the container receiving part 110, the dedicated container 160 is engaged with a plurality of contacts 175 formed on the upper surface of the measuring part 170 to measure various information of the food.

The measuring part 170 can be composed of a measurement module kit which contains therein a sensor to measure the weight, salinity, temperature or the like of the food through the electrodes 161 of the dedicated container 160. When the dedicated container 160 served with food is received in the container receiving part 110, the measuring part 170 can measure the weight, salinity, temperature or the like of the food served in the dedicated container 160. The information measured as such is transmitted to a control part (not show in FIG. 2) and processed therein, which can be indicated in the display part 130 or outputted as a sound through the speaker part 140.

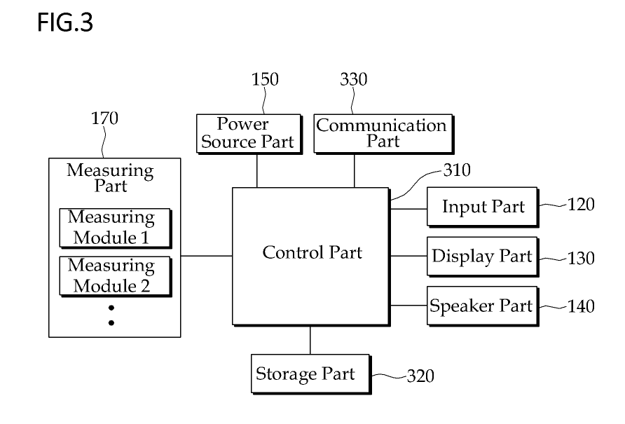

FIG. 3 is a conceptual view illustrating the construction of the functional meal plate in accordance with a preferred embodiment of the present invention.

Referring to FIG. 3, the functional meal plate includes an input part 120, a display part 130, a speaker part 140, a power source part 150, a measuring part 170, a control part 310, a storage part 320, and a communication part 330.

The control part 310 is connected with all the other component parts to control the function of the respective component parts. For instance, when the measuring part 170 includes a plurality of measurement modules, e.g., a first measurement module, a second measurement module or the like which are disposed under the respective container receiving parts 110, the data values measured at each measurement module can be transferred to the control part 310. The control part 310 consolidatedly processes the data values received from each measurement module, so as to sum up the total amount of the food eaten by the user and the salinity of the food, add up the data values stored for a certain period of time such as a day, a week, a month or the like, or perform a function to calculate the calories consumed by the user from the amount of the food consumed by him/her.

The data values processed in the control part 310 as such can be stored in the storage part 320. The storage part 320 is designed to store the corresponding information after every meal, which makes it possible to store the amount of the food and the calories consumed at each meal and the temperature of the food, and further store the data values being aggregated for a certain period of time such as a day, a week, a month or the like. Such data values can be outputted through the display part 130, so that the user is able to monitor his/her eating habits of every meal as well as those from the aspect of a middle and long term basis like a daily, weekly or monthly unit. The functions as such can be advantageously utilized by various categories of people like athletes, ordinary persons seeking obesity controls, teenagers and children needing nutrition managements, patients with the need of diet controls or the like.

The functional meal plate includes a communication part 330 to transmit the information stored in the storage part 320 to an outside terminal. The communication part 330 includes a communication module to support wired and wireless communication networks. The information stored in the storage part 320 can be delivered to a user terminal like a smartphone or a personal computer through the communication part 330.

For example, the communication part 330 can use a short-distance wireless network, and include one communication module out of a ZigBee, a Bluetooth, a UWB (Ultra wide Band), and a WiFi network. By means of such a short-distance wireless network, the information can be transmitted to the user's terminal, which makes it possible for the user to conveniently utilize the information. Furthermore, the users may create a communication community to share the information on their dietary life to each other, and download such information so as to allow the professionals, for example, physicians or nutritionists to make reference thereto.

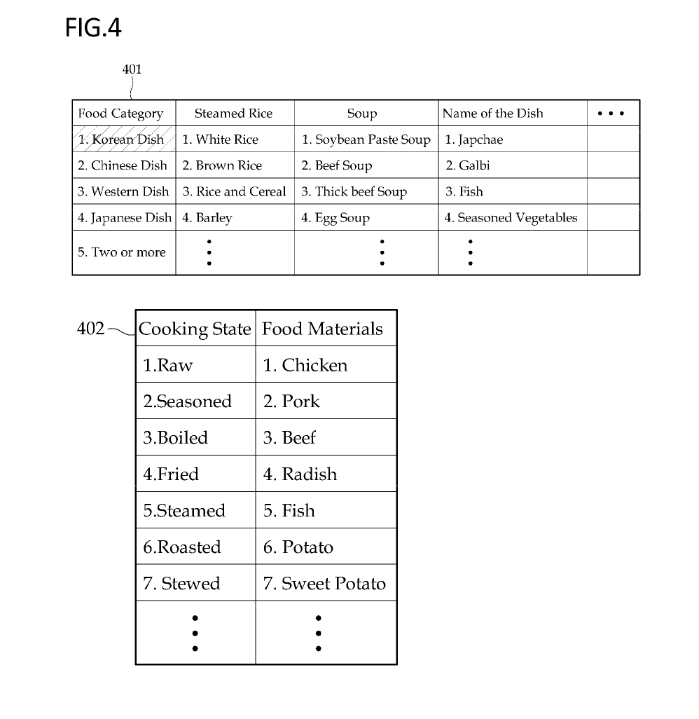

FIG. 4 is a view illustrating a menu screen which can input the kind and cooking state of food.

To retrieve calories of the food and nutrition information thereof, it is very important to monitor the kind or cooking state of the food or the dishes served in the container of the meal plate. Referring to FIG. 4, the display part 130 includes a screen 401 on which food categories can be displayed, and the user can input the kind of the steamed rice and the soup as well as the name of the food based on the selection of the food category, and another screen 402 on which the user can input a cooking state and a food material.

The user, by means of the input part 120, can choose one out of a Korean dish, a Chinese dish, a Western dish, a Japanese dish, a combination of two or more or the like. When the user selects the Korean dish, a menu to choose the kind of a cooking state according to the Korean dish comes up. For instance, as shown in FIG. 4, the user can input the kind of the steamed rice and the soup, and the name of the side dishes. The kind of the steamed rice may include white rice, brown rice, rice with cereals, barley or the like. In addition, the kind of the soup may include a soybean paste soup, a beef soup, a thick beef soup, an egg soup, a Kimchi soup, a beef broth, a dried pollack soup, a radish soup or the like. The name of the dish may include a Japchae (chop suey), Galbi (beef or pork ribs), fish, seasoned vegetables or the like.

Further, it should be noted that the user can input the cooking state and the food material through the input part 120. For example, the user can select one or more items out of the cooking states including whether it is raw, seasoned, boiled, fried, steamed, roasted, and stewed or the like. Besides, the user can choose one or more items of the food materials including chicken, pork, beef, radish, fish, potatoes, sweet potatoes or the like. For instance, according to the input combination by the user, the user can make the name of the food material indicating the cooking state such as a roasted chicken, boiled pork, a broiled fish, a roasted potato, a seasoned radish or the like.

Furthermore, it should be appreciated that since the respective menu items have a function to add an input item by the user's definition, when the kind of the food is not yet defined, the user can select a certain food together with the other menu by inputting and setting the corresponding calories he/she wanted to consume.

According to the present invention, it can achieve the management of eating habits of patients who need an obesity control or food moderation as well as the management and improvement of eating habits of an ordinary person. In the case of the ordinary person, the present invention can help systematically and professionally manage a user's health by monitoring his/her eating habits on a long-term basis such as every day, week, month or the like, instead of applying stress to the user by generating a warning sound whenever he/she eats an amount of a meal beyond the predetermined level every meal.

In addition, in accordance with the present invention, it further includes a salinity sensor and a temperature sensor, which are able to guide healthy eating habits through the measurement of salt contents consumed by the user and the temperature of the food, thereby preventing the user from getting various diseases, esophagitis or the like.

Further, according to the present invention, the meal plate is in connection with a terminal such as a smartphone or the like, such that it can provide a better service which is convenient to the user and can be informed of systematic and professional information from experts.

It should be appreciated that the functional meal plate according to the present invention can be used by patients as well as a variety of people, such as ordinary healthy persons, athletes who need a special care, teenagers, kids or the like.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A meal plate comprising:
a plurality of container receiving parts for receiving a container to serve food;
an input part for inputting the kind of the food served in the container which is received in the container receiving parts;
a measuring part disposed under the container receiving part for measuring information of the food served in the container;
a storage part for storing the information of the food measured in the measuring part; and
a communication part for transmitting the information of the food stored in the storage part to a user terminal.

2. The meal plate as recited in claim 1, wherein the information of the food includes weight changes of the food and salinity of the food.

3. The meal plate as recited in claim 2, wherein the information of the food further includes temperature of the food.

4. The meal plate as recited in claim 1, wherein the information of the food can be stored for every meal.

5. The meal plate as recited in claim 4, wherein the information of the food can be summed up for every day, week or month.

6. The meal plate as recited in claim 1, further comprises an outputting part for indicating the information of the food to a user.

7. The meal plate as recited in claim 6, wherein the outputting part displays a selection menu for the user to choose the kind of the food and at least one of the cooking states of the food, and wherein the user can select the kind of the food and at least one of the cooking states of the food through the input part.

8. The meal plate as recited in claim 1, wherein the container to serve the food includes electrodes, and wherein the electrodes are connected with the measuring part through the container receiving parts.

9. The meal plate as recited in claim 1, wherein the input part is designed to be able to input the cooking state of the food.

10. The meal plate as recited in claim 1, wherein the user terminal is a wireless communication terminal or a personal computer of the user.

11. The meal plate as recited in claim 1, wherein the communication part transmits the information of the food through a short-distance wireless network.

12. The meal plate as recited in claim 11, wherein the short-distance wireless network includes one out of a ZigBee, a Bluetooth, a UWB (Ultra wide Band), and a WiFi network.

13. A meal plate comprising:
a plurality of container receiving parts for receiving a container to serve food;
a measuring part disposed under the container receiving part and provided with sensors to measure the weight, salinity and temperature of the food served in the container;
a storage part for storing weight changes, salinity and temperature of the food measured in the measuring part;
an outputting part for displaying the weight changes, salinity and temperature of the food; and
a communication part for transmitting the weight changes, salinity and temperature of the food stored in the storage part to a user terminal.

14. The meal plate as recited in claim 13, wherein the container to serve the food comprises electrodes, and wherein the measuring part is connected with the electrodes to measure the weight, salinity and temperature of the food through the electrodes of the container receiving parts.

15. The meal plate as recited in claim 13, further comprising an input part for inputting the kind of the food served in the container and the cooking state of the food.
